(19) United States
(12) Patent Application Publication
(10) Pub. No.: US 2021/0129738 A1
(43) Pub. Date: May 6, 2021

(54) DAMPING SYSTEM FOR A VEHICLE HEADLAMP

(71) Applicant: AML SYSTEMS, Paris (FR)

(72) Inventors: Hassan Koulouh, Le Pré Saint Gervais (FR); Cyril Rivier, Courbevoie (FR)

(73) Assignee: AML SYSTEMS, Paris (FR)

(21) Appl. No.: 16/472,769

(22) PCT Filed: Dec. 21, 2017
(86) PCT No.: PCT/FR2017/053783

§ 371 Date: Sep. 20, 2019

(30) Foreign Application Priority Data
Dec. 23, 2016 (FR) 1663315

(51) Int. Cl. B60Q 1/04

(52) U.S. Cl. CPC B60Q 1/0491

(57) ABSTRACT

The present disclosure provides a damping system for a vehicle headlamp having a housing and an optical module provided with a light source. The damping system includes a damping module, a first linking module configured to link the optical module to the damping module and a second linking module configured to link the housing to the damping module. The damping module is configured such that, when a force with a value less than a predetermined value is exerted on the optical module, the optical module remains fixed relative to the housing, and when a force with a value greater than the predetermined value is exerted on the optical module, the optical module moves resiliently relative to the housing.

### TECHNICAL FIELD

The present invention relates to a damping system for a vehicle headlamp.

### STATE OF THE ART

A vehicle headlamp comprises a support housing carrying an illumination module in an adjustable manner. The illumination module usually contains at least a reflector and a light source emitting a light beam. The adjustment of the position of the illumination module makes it possible to adjust the orientation of the light beam. Said adjustment is made by at least an adjustment system, otherwise called illumination corrector. Generally, the illumination module is maintained in three linking points: a fixing point is fixed and two fixing points are linked respectively to an adjustment system. This configuration makes it possible to adjust the orientation of the light beam laterally and vertically.

Generally, the support housing is closed by a glass. This glass plays a role of protecting the mechanism of the adjustment system against bad weather such as snow or a malicious act. Yet, in the case where the support housing of the headlamp is not closed by a glass, a need can exist to protect the mechanism of said adjustment system.

### DESCRIPTION OF THE INVENTION

The present invention aims to meet this need.

To this end, the invention relates to a damping system for a vehicle headlamp, said headlamp comprising a housing containing an optical module provided with a light source.

According to the invention, the damping system comprises at least:
a damping module;
a first linking module configured to link the optical module to the damping module;
a second linking module configured to link the housing to the damping module.

The damping module is configured so that:
when at least a force with a value less than at least a predetermined value is exerted on the optical module, the optical module remains fixed relative to the housing, and
when at least a force with a value greater than at least a predetermined value is exerted on the optical module, the optical module moves resiliently relative to the housing.

Thus, the damping module makes it possible to retract the optical module when an excess force or a certain force is applied on the optical module. This makes it possible, for example, to protect a control device configured to adjust the position of the optical module.

According to an embodiment, the first linking module comprises a first end of a control rod having a longitudinal axis, the first end being configured to be linked to the optical module; the second linking module comprising a second end of the control rod and a drive module, the drive module being configured to be linked to the housing and to drive the control rod in a first direction or a second direction parallel to the longitudinal axis,

the damping module being configured so that:
the first end of said rod progressively approaches the second end as soon as the force corresponds to a first force parallel to the longitudinal axis and of a value greater than a first predetermined value is exerted on the first end in a direction oriented towards the second end,
the first end of said rod progressively extends from the second end, as soon as the force corresponds to a second force parallel to the longitudinal axis and of a value greater than a second predetermined value is exerted on the first end in a direction opposite the second end.

In addition, the distance between the first end of the control rod and the second end is substantially equal to a nominal length which remains constant as long as the first force has a value less than the first predetermined value and as long as the second force has a value less than the second predetermined value.

Furthermore, the control rod comprises two portions configured to slide against one another in the direction of the longitudinal axis, a first portion comprising the first end of said rod, a second portion comprising the second end of said rod.

According to a first embodiment variant, the first portion of the control rod slides into the second portion of said rod, the first portion of said rod comprising a first sliding end opposite the first end of said rod, the second portion of said rod comprising a second sliding end opposite the second end of said rod, the damping module comprising:
a chamber located at the second sliding end, the chamber being delimited, on the one hand, by a wall extending longitudinally from the second portion, and on the other hand, by a first wall and a second wall perpendicular to the longitudinal axis, the first and the second walls each comprising an opening, letting the first portion of said rod pass,
an abutment fixed to the first sliding end, the abutment being comprised in the chamber,
at least two dampers comprised in the chamber, arranged on either side of the abutment respectively, such that the dampers tend to bring the abutment to a predetermined position in the chamber, such that the control rod has a length equal to the nominal length.

According to a second embodiment variant, the second portion of the control rod slides into the first portion of said rod, the first portion of said rod comprising a first sliding end opposite the first end of said rod, the second portion of said rod comprising a second sliding end opposite the second end of said rod, the damping module comprising:
a chamber located at the first sliding end, the chamber being delimited, on the one hand, by a wall extending longitudinally from the first portion, and on the other hand, by a first wall and a second wall perpendicular to the longitudinal axis, the first and the second walls comprising an opening, letting the second portion of said rod pass,
an abutment fixed to the second sliding end, the abutment being comprised in the chamber,
at least two dampers comprised in the chamber, arranged on either side of the abutment respectively, the dampers tending to bring the abutment to a predetermined position in the chamber, such that the control rod has a length equal to the nominal length.

Moreover, at least a damper corresponds to a coil spring.

The invention also relates to a vehicle headlamp comprising at least an adjustment system such as described above.

### BRIEF DESCRIPTION OF THE FIGURES

The invention, with its characteristics and advantages, will emerge more clearly upon reading the description made in reference to the appended drawings, wherein:

FIG. 1 represents a perspective view of a glassless vehicle headlamp according to an embodiment,

FIG. 2 represents a transversal cross-section of the glassless vehicle headlamp according to an embodiment,

FIG. 3 represents a longitudinal cross-section of the adjustment device,

FIG. 4 represents a curve whose abscissa axis represents the difference between the nominal length of the control rod and the current length of the control rod, the ordinate axis representing the force exerted on the end of the control rod.

### DETAILED DESCRIPTION

Below, the description will make reference to the figures cited above.

The invention relates to a damping system for a vehicle headlamp 1. Said headlamp 1 comprises a housing 15 containing an optical module 5 (or illumination module) provided with a light source.

Said headlamp 1 is preferably a glassless headlamp.

The damping system comprises at least:
a damping module 7;
a first linking module configured to link the optical module 5 to the damping module 7;
a second linking module configured to link the housing 15 to the damping module 7.

The damping module 7 is configured so that the optical module 5 remains fixed relative to the housing 15, when at least a force with a value less than at least a predetermined value is exerted on the optical module 5.

The damping module 7 is also configured so that the optical module 5 moves resiliently relative to the housing 15, when at least a force with a value greater than at least a predetermined value is exerted on the optical module 5.

The damping system can be achieved according to several embodiments making it possible to retract the optical module 5 when an excess force is applied on it. The damping module 7 makes it possible, for example, to retract the optical module 7 in translation or in rotation.

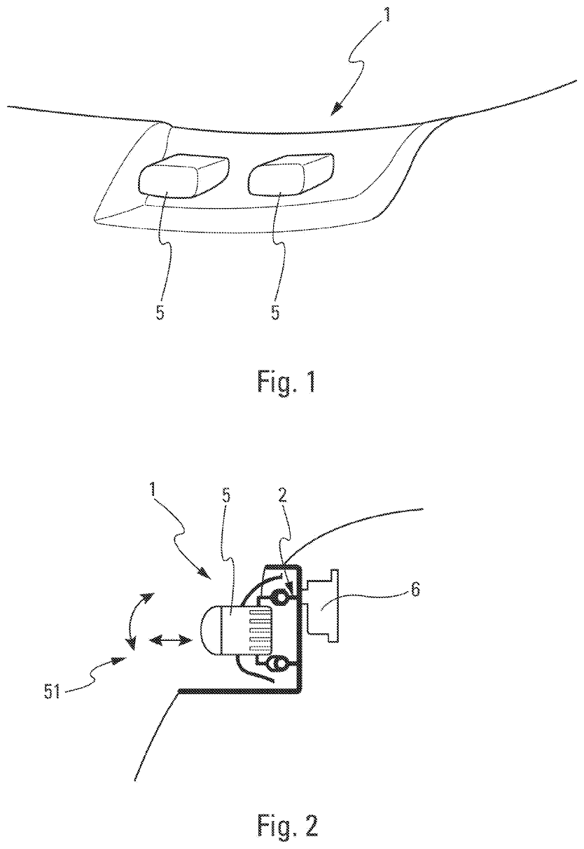

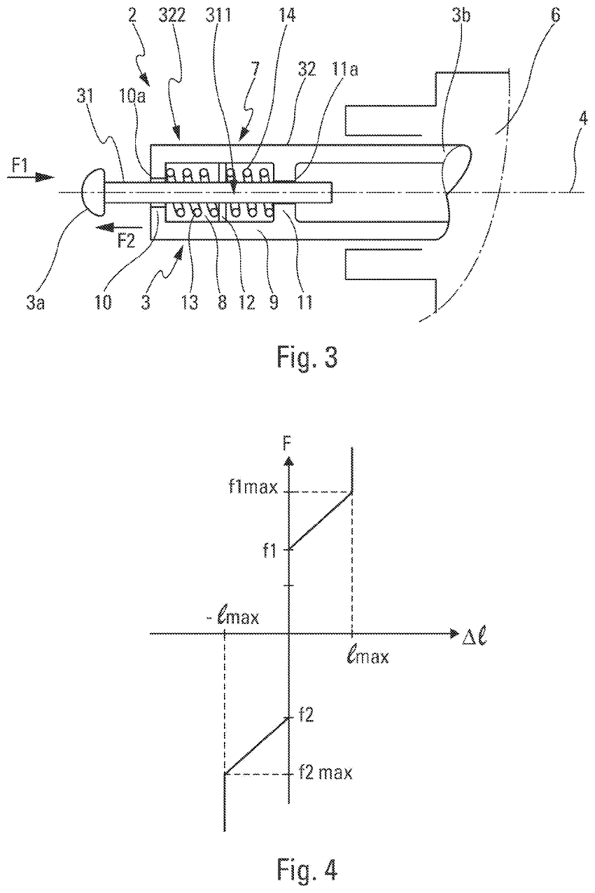

According to an embodiment represented in FIGS. 2 and 3, the damping system comprises a device for controlling 2 a system for adjusting the orientation of a light beam emitted by a light source comprised in the optical module 5 (FIG. 2) for a vehicle headlamp 1 (FIG. 1). The damping system comprises a rod for controlling the control device 2.

As represented in FIG. 3, the first linking module comprises an end 3a of the control rod 3 having a longitudinal axis 4.

The end 3a is configured to be linked to the optical module 5.

For example, the end 3a is linked to the optical module 5 by way of a ball joint link.

The second linking module comprises an end 3b of the control rod 3 and a drive module 6.

The drive module 6 is configured to be linked to the housing and to drive the control rod 3 in a first direction or a second direction, parallel to the longitudinal axis 4, in a translation movement.

The translation movement of the control rod 3 according to the longitudinal axis makes it possible to modify the orientation of the optical module 5. The reference 51 of FIG. 3 represents examples of movements of the optical module 5 to change its orientation.

The control rod 3 further comprises a damping module 7.

The damping module 7 is configured so that the end 3a of the control rod 3 progressively approaches the end 3b as soon as the force exerted on the optical module 5 corresponds to a force F1 parallel to the longitudinal axis 4 and of a value greater than a first predetermined value f1 exerted on the end 3a in a direction oriented towards the end 3b.

The damping module 7 is also configured so that the end 3a of said rod 3 progressively extends from the second end 3b as soon as the force exerted on the optical module 5 corresponds to a force F2 parallel to the longitudinal axis 4 and of a value greater than a second predetermined value f2 exerted on the end 3a in a direction opposite the end 3b.

Preferably, the distance between the end 3a of the control rod 3 and the end 3b is substantially equal to a nominal length which remains constant while the force F1 has a value less than the predetermined value f1 and while the force F2 has a value less than the predetermined value f2.

According to a configuration of the system, the control rod 3 reaches a minimum length when the force F1 reaches a third predetermined value f1max. Likewise, the control rod 3 reaches a maximum length when the force F2 reaches a fourth predetermined value f2max.

According to an embodiment, the predetermined value f1 of the force F1 is substantially equal to the opposite of the predetermined value f2 of the force F2.

In a non-limiting manner, the absolute value of the predetermined value of the force F1 and the absolute value of the predetermined value of the force F2 are substantially equal to 100N.

According to an embodiment, the third predetermined value f1max of the force F1 is substantially equal to the opposite of the fourth predetermined value f2max of the force F2.

FIG. 4 represents a curve in a marker whose abscissa axis represents the different Δl between the nominal length of the control rod 3 and the current length of the control rod 3. The ordinate axis represents the force F exerted on the end 3a of the control rod 3. The curve makes it possible to see that the control rod 3 has a length which remains equal to a constant nominal length to a predetermined value f1 or f2 of force F1 or F2 applied on the end 3a of the control rod 3. If the force F1 or F2 continues to increase by exceeding the predetermined value f1 or f2, the length of the control rod 3 decreases or increases progressively to reach a minimum length or a maximum length from a predetermined value f1max or f2max. The term Imax in FIG. 4 is equal to the difference between the nominal length and the current length when the control rod 3 reaches its minimum or maximum length.

According to an embodiment, the control rod 3 comprises two portions 31 and 32 configured to slide against one another, in the direction of the longitudinal axis 4. A portion 31 comprises the end 3a of said rod 3. A portion 32 comprises the end 3b of said rod 3.

According to a first embodiment variant (FIG. 3), the portion 31 of the control rod 3 slides into the portion 32 of said rod 3. The portion 31 of said rod 3 comprises a sliding end 311 opposite the end 3a of said rod 3. The portion 32 of said rod 3 comprises a sliding end 322 opposite the end 3b of said rod 3.

The damping module 7 comprises a chamber 8 located at the sliding end 322. The chamber 8 is delimited, on the one hand, by a wall 9 extending longitudinally from the portion 32, and on the other hand, by a wall 10 and a wall 11 perpendicular to the longitudinal axis 4. The walls 10 and 11 each comprise an opening 10a and 11a letting the portion 31 of said rod 3 pass. Preferably, the shape of the openings 10a and 11a is complementary to the transversal cross-section of the portion 31.

The damping module 7 further comprises an abutment 12 fixed to the sliding end 311. The abutment 12 is confined in the chamber 8.

The damping module 7 also comprises at least two dampers 13 and 14 confined in the chamber 8. The dampers 13 and 14 are arranged on either side of the abutment 12 respectively, such that the dampers 13 and 14 tend to bring the abutment 12 to a predetermined position in the chamber 8 such that the control rod 3 has a length equal to the nominal length.

According to a second embodiment variant (not represented), the second portion of the control rod 3 slides into the first portion of said rod.

In this second variant, the chamber is located at the first sliding end. The chamber is delimited, on the one hand, by a wall extending longitudinally from the first portion, and on the other hand, by a first wall and a second wall perpendicular to the longitudinal axis. The first and second walls comprise an opening letting the second portion of said rod 3 pass.

The abutment, confined in the chamber, is fixed to the second sliding end.

In a non-limiting manner, at least a damper 13 and/or 14 corresponds to a coil spring.

The predetermined values f1 and f2 of the forces F1 and F2 can therefore be controlled by the stiffness of the coil spring(s). The predetermined values f1max and f2max can be controlled by the length of the chamber 8.

The present description details different embodiments in reference to the figures and/or technical characteristics. A person skilled in the art will understand that the various technical characteristics of the various embodiments or configurations can be combined together to obtain other embodiments and configurations, unless the opposite is explicitly mentioned, or unless these technical characteristics are incompatible. Likewise, a technical characteristic of an embodiment or of a configuration can be isolated from the other technical characteristics of this embodiment, unless the opposite is mentioned. In the present description, numerous specific details are provided as examples, and in a not-at-all limiting manner, so as to specifically detail the invention. A person skilled in the art will however understand that the invention can be achieved in the absence of one or more of these specific details or with variants. On other occasions, certain aspects are not detailed so as to avoid complicating and encumbering the present description and a person skilled in the art will understand that the various and varied means can be used and that the invention is not limited to only the examples described.

It must be clear for persons skilled in the art that the present invention makes it possible for embodiments under numerous other specific forms without moving away from the field of application of the invention as claimed. Consequently, the present embodiments must be considered as examples, but can be modified in the field defined by the scope of the appended claims, and the invention must not be limited to the detailed given above.

1. A damping system for a vehicle headlamp having a housing containing an optical module provided with a light source, the damping system comprising:
a damping module;
a first linking module configured to link the optical module to the damping module; and
a second linking module configured to link the housing to the damping module;
wherein the damping module is configured such that:
when a force has a value that is less than a predetermined value and is exerted on the optical module, the optical module remains fixed relative to the housing, and
when the force has a value that is greater than the predetermined value and is exerted on the optical module, the optical module moves resiliently relative to the housing.

2. The damping system according to claim 1,
wherein:
the first linking module comprises a first end of a control rod having a longitudinal axis, the first end being configured to be linked to the optical module;
the second linking module comprises a second end of the control rod and a drive module, the drive module being configured to be linked to the housing and to drive the control rod in a first direction or a second direction that are parallel to the longitudinal axis, and
the damping module is configured such that:
the first end of said control rod progressively approaches the second end as soon as the force corresponds to a first force that is parallel to the longitudinal axis, has a value greater than a first predetermined value, and is exerted on the first end in a direction oriented towards the second end, and
the first end of said control rod progressively extends from the second end as soon as the force corresponds to a second force that is parallel to the longitudinal axis, has a value greater than a second predetermined value and is exerted on the first end in a direction opposite the second end.

3. The damping system according to claim 2,
wherein a distance between the first end of the control rod and the second end is substantially equal to a nominal length which remains constant as long as the first force has a value less than the first predetermined value and as long as the second force has a value less than the second predetermined value.

4. The damping system according claim 3,
wherein the control rod comprises a first portion and a second portion that are configured to slide against one another in the direction of the longitudinal axis, the first portion comprising the first end of said control rod, and the second portion comprising the second end of said control rod.

5. The damping system according to claim 4,
wherein the first portion of the control rod is configured to slide into the second portion of said control rod, the first portion of said control rod comprising a first sliding end opposite the first end of said control rod, the second portion of said control rod comprising a second sliding end opposite the second end of said control rod, and
wherein the damping module comprises:
a chamber located at the second sliding end, the chamber being delimited by a wall extending longitudinally from the second portion and by a first wall and a second wall perpendicular to the longitudinal axis, the first and the second walls each comprising an opening letting the first portion of said control rod pass,
an abutment fixed to the first sliding end, the abutment being located in the chamber; and
at least two dampers located in the chamber that are arranged on either side of the abutment, respectively, such that the at least two dampers are configured to bring the abutment to a predetermined position in the chamber, such that the control rod has a length equal to the nominal length.

6. The damping system according to claim 4, wherein
the second portion of the control rod is configured to slide into the first portion of said control rod,
the first portion of said control rod comprises a first sliding end opposite the first end of said control rod and the second portion of said control rod comprises a second sliding end opposite the second end of said control rod, and
the damping module comprises:
a chamber located at the first sliding end, the chamber being delimited by a wall extending longitudinally from the first portion, and by a first wall and a second wall perpendicular to the longitudinal axis, the first and the second walls comprising an opening that is configured to allow the second portion of said control rod to pass;
an abutment fixed to the second sliding end, the abutment being located in the chamber; and
at least two dampers located in the chamber and arranged on either side of the abutment respectively, the dampers being configured to bring the abutment to a predetermined position in the chamber, such that the control rod has a length equal to the nominal length.

7. The damping system according to claim 6,
wherein each of the at least two dampers includes a coil spring.

8. A vehicle headlamp, comprising: the damping system according to claim 1.
